(19) United States
(12) Patent Application Publication
(10) Pub. No.: US 2020/0025530 A1
(43) Pub. Date: Jan. 23, 2020

(54) DENIER GRADIENT CORE MATRIX BALLISTIC MATERIAL

(71) Applicant: Tex Tech Industries, Inc., North Monmouth, ME (US)

(72) Inventors: Robert GRAVEL, Greene, ME (US); Scott JANCO, Portland, ME (US); Courtney MUSCIANO, Portland, ME (US); Allen L. PRICE, Rising Sun, MD (US)

(73) Assignee: Tex Tech Industries, Inc., North Monmouth, ME (US)

(21) Appl. No.: 16/287,288

(22) Filed: Feb. 27, 2019

Related U.S. Application Data
(63) Continuation of application No. 14/816,458, filed on Aug. 3, 2015, now abandoned.
(60) Provisional application No. 62/086,917, filed on Dec. 3, 2014.

(51) Int. Cl. F41H 5/04; B32B 7/08; B32B 5/02; B32B 5/26

(52) U.S. Cl. CPC F41H 5/0485; B32B 7/08; B32B 5/022; B32B 5/024; B32B 5/26; B32B 2571/02; B32B 2262/0276; B32B 2262/106; B32B 2262/08; B32B 2262/0261; B32B 2262/0269; B32B 2262/0253; B32B 2262/12

(57) ABSTRACT

A ballistic material is made from a plurality of ballistic grade woven fabric layers of different denier which are processed by needlepunching with nonwoven ballistic fibers into core components for ballistic vests and the like.

### CROSS REFERENCE TO RELATED APPLICATIONS

This is a continuation application of U.S. Ser. No. 14/816,458, filed on Aug. 3, 2015 which claims the benefit of U.S. Provisional Application No. 62/086,917, filed Dec. 3, 2014, both of which are incorporated by reference herein in their entirety.

### FIELD OF THE INVENTION

The invention is in the field of ballistic materials. Specifically, the invention is directed to a ballistic material made from a plurality of ballistic grade woven fabric layers of different denier which can be processed by needlepunching to form core matrix component layers for ballistic vests and the like.

### BACKGROUND OF THE INVENTION

U.S. Pat. Nos. 7,101,818 and 7,631,405, which are incorporated by reference in their entirety, describe ballistic materials and methods in which woven ballistic layer(s) are reinforced with ballistic fibers driven by needlepunching into the interstices of the woven layer(s) to form a consolidated material. The “z-directional reinforcement” improves ballistic performance compared to multiple plies of the woven ballistic fabric stitched together. The component parts of a ballistic construction made according to this method are referred to as “core matrix” materials.

U.S. Patent Publication 2003/0022583 describes a ballistic material made from multiple layers of ballistic fabric consolidated by needlepunching. The layers are made from different types of fiber, and one of the materials has a melting temperature lower than the other and deforms differently upon impact. This construction is said to improve performance in a ballistic event, yielding increased V-50 velocities compared to materials made from the individual components at comparable areal weights.

There continues to be a need for ballistic materials which can be readily processed into a variety of product configurations, which exhibit good resistance to ballistic penetration and at the same time reduce trauma experienced during a ballistic event. These and other objects of the invention are achieved with the product and according to the methods of the invention as described below.

### SUMMARY OF THE INVENTION

These and other objects of the invention are achieved with a ballistic material, comprising: a first woven ballistic fabric having a first denier in a range of 50 d to 5000 d; and a second woven ballistic fabric having a second denier in a range of 50 d to 5000 d, wherein the second woven ballistic fabric has a denier at least 15% greater than the first woven fabric. The first and second woven ballistic fabrics are consolidated with a loose fiber nonwoven layer by needle punching to form a core material. The resulting “denier gradient” core matrix material yields improved ballistic properties in terms of both V-50 penetration and trauma performance.

### BRIEF DESCRIPTION OF THE DRAWINGS

FIG. 1 shows plotted V-50 performance data of a sample ballistic fabric according to an embodiment of the invention, using different caliber rounds.

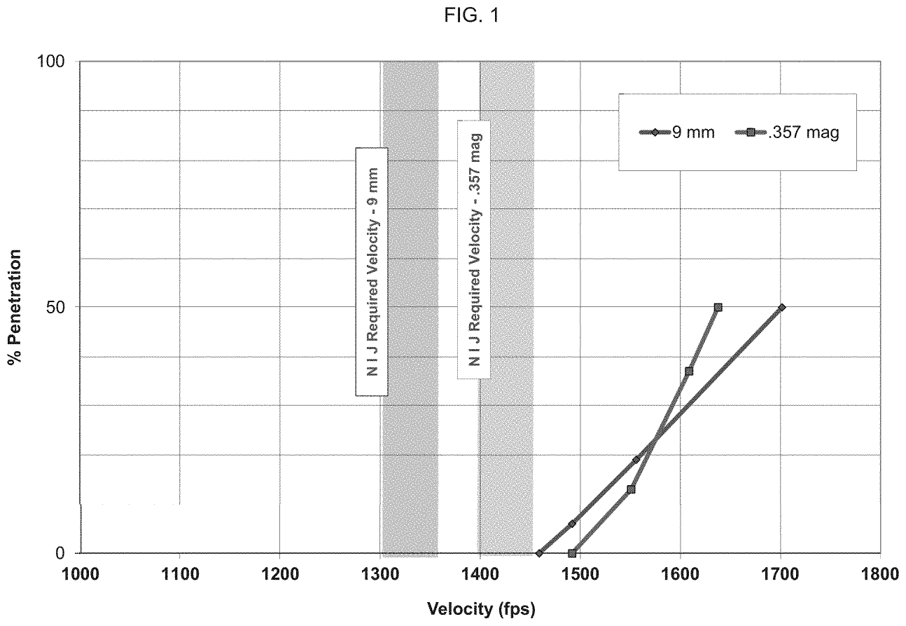

FIG. 2 shows plotted backface signature performance data of a sample ballistic fabric according to the invention.

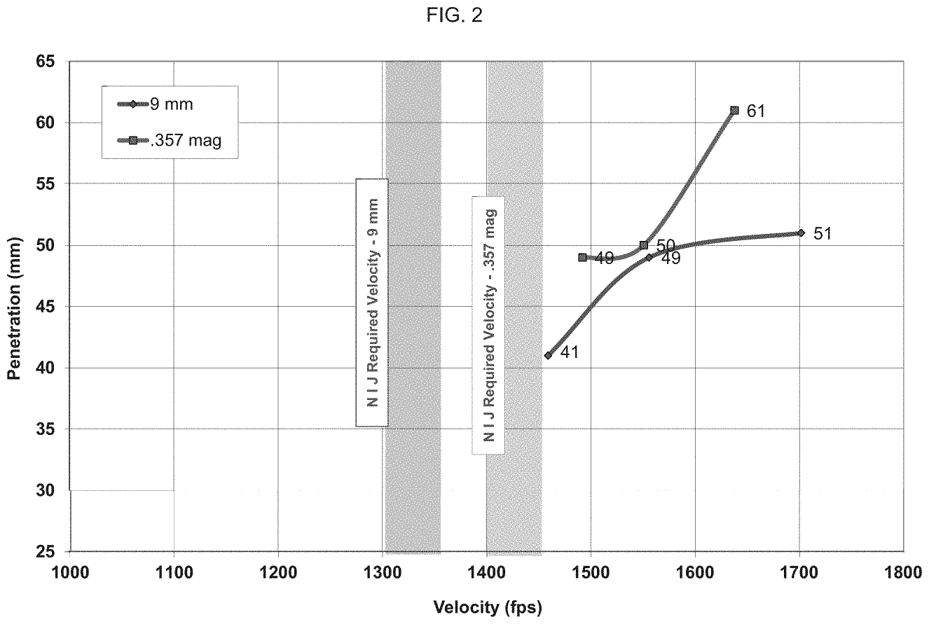

FIG. 3 shows plotted V-50 data for sample ballistic fabrics using different amount of woven and core material.

FIG. 4 show plotted data demonstrating the effect of increasing the amount of loose fiber batting incorporated into a material according to the invention.

FIG. 5A and FIG. 5B show improvement in Backface Signature (BFS) and V50 for a first dual denier needlepunched ballistic fabric according to the invention compared to a first single denier ballistic material.

FIG. 6A and FIG. 6B show improvement in Backface Signature (BFS) and V50 for the dual denier needlepunched ballistic fabric of FIG. 5A, compared to a second single denier ballistic material.

FIG. 7A and FIG. 7B show improvement in Backface Signature (BFS) and V50 for a second dual denier needlepunched ballistic fabric according to the invention compared to a third single denier ballistic material.

FIG. 8A and FIG. 8B show improvement in Backface Signature (BFS) and V50 for a third dual denier needlepunched ballistic fabric according to the invention compared to a fourth single denier ballistic material.

### DETAILED DESCRIPTION OF THE INVENTION

“Denier” and the abbreviation “d” refers to a measure of linear density of yarn, specifically the weight in grams of 9000 meters of yarn.

“Monolithic” refers to a structure of a fully consolidated material, having the same appearance and density across the material thickness. In contrast, a material with visibly different layers across its thickness is not monolithic.

“V-50” is a standard test of ballistic performance and refers to the velocity at which 50 percent of rounds fired at a specified ballistic target pass through the target. Thus, higher V-50 indicates better ballistic performance.

Backface signature (“BFS”) is another standard test of ballistic performance related to the trauma inflicted in a ballistic event, and refers to the depth of an imprint made in a clay surface positioned behind the test material when a round is fired at the material. Thus, smaller BFS correlates to less trauma inflicted in a ballistic event, and is a desired characteristic.

The inventors have generally observed that high denier fibers such as 3000d, 1500d and 1000d exhibit good engagement of large caliber rounds such as .44 Magnum and .357 Magnum at muzzle velocity. However, these fabrics typically exhibit relatively poorer engagement of small caliber high velocity rounds (such as 9 mm rounds) at muzzle velocity.

Further, while engagement of the large caliber rounds is good at muzzle velocity, the V-50 performance of these materials is not correspondingly high. V-50 of low denier fibers between the range of 100 d and 850 d are typically higher against both high velocity rounds, such as 9mm, and large caliber rounds, such as .357 mag and .44 mag, compared to larger denier fabrics at equivalent weights.

Low denier fabrics (including the range of 100 d to 850 d, for example) have been observed to engage high velocity, smaller caliber rounds (such as 9 mm) quite well. However, BFS performance against large caliber rounds with these same low denier fabrics is typically not very good.

The inventors have found that hybridization of high denier fabrics with low denier fabrics, together with nonwoven fibers, using the consolidation processes according to the invention produces both higher V-50' s and lower BFS against both smaller, high velocity rounds, such as 9 mm, as well as against large caliber rounds such as .357 mag and .44 mag. This discovery has led to lighter weight body armor with better performance at muzzle velocities and better V-50 performance overall.

The technique of making the core matrix material, consolidated by needlepunching from a plurality of different denier fabrics, improves manufacturing efficiencies, permitting standardized core material to be layered in different end product configurations.

A ballistic construction according to the invention includes a first woven ballistic layer having a relatively low denier (the “low denier layer(s)”), and a second woven ballistic layer having a relatively high denier (the “high denier layer(s)”). In embodiments the ballistic material comprises 1 to 20 layers of the first woven ballistic fabric and 1 to 20 layers of the second woven ballistic fabric. The high denier layer has a denier at least about 15% greater, and preferably at least about 35% greater, than the low denier material. In embodiments, the high denier layer has a denier that is 50% greater, or more, than the low denier material.

The first and second woven ballistic layers may be made from the same or different ballistic grade fibers. Combining layers woven from different denier yarns of the same material consolidated by needle punching has been shown to yield improved and in many cases unexpected results. However, the invention is not limited to using the same fiber material. The invention is not limited to a particular ballistic grade fiber. Preferably, the ballistic grade fibers for each layer are selected from ballistic grade poly(amide), para-aramid, ultra-high molecular weight polyethylene (UHMWPE) fibers, polyester, and poly(phenylene-2,6-benzobisoxazole) (PBO) fibers. Other fibers may be used, including graphene, spider silk, and carbon nanotubes, multi-component fibers or co-polymer materials including any of the fibers listed above, and any other fiber material which involves further treatment or processing of such fibers. Preferably, ballistic grade fibers used to form the woven ballistic layer have a tenacity of at least 15 grams per denier (13.5 g/decitex) and a tensile modulus of at least 400 grams per denier (360 g/decitex).

The denier of the woven ballistic layers may be any denier between 50 and 5000 d, provided that the denier of the low denier woven layer is significantly lower than the denier of the high denier woven layer. Preferably, the low denier woven layer has a denier of 50 d to 1500 d, and preferably 125 to 850 d Likewise, the denier of the high denier layer is not particularly limited, but is preferably in the range of 500 d to 5000 d to provide a sufficient denier gradient, and in certain embodiments is in a range of 1000 d to 3500 d. As used herein, the terms “high denier” and “low denier” are relative rather than absolute terms. In a ballistic material according to the invention comprising 2 to 10 layers of woven para aramid fibers having a denier of about 400 d, and 2 to 10 layers of woven para aramid fibers having a denior of about 600d, the woven layers being consolidated together with nonwoven fibers by needlepunching, the 600 denier fibers are the “high denier” fibers. The type of weave in the different layers may be the same or different and is not particularly limited. Exemplary weaves that can be used for woven layers includes, without limitation, plain, twill, basket, satin, leno, mock leno, sateen and combinations thereof.

Double weaves, triple weaves, quad weaves and offset weaves may also be used. In embodiments, different weaves of different denier are provided in the consolidated material to improve the interaction of the material with a projectile in a ballistic event. A similar advantage may be gained using a double weave, such as disclosed in US 2014/0065907, which is incorporated by reference.

A ballistic construction according to the invention also includes nonwoven fibers entangled with the low denier layer and the high denier layer. The nonwoven fibers are loose ballistic grade or non-ballistic grade fibers, for example, and not by way of limitation, aramid, para-aramid, polypropylene, polyester, nylon, poly (p-phenylene2,6-benzobisoxazole) (PBO), and spunlace fibers, or a combination thereof. In certain embodiments loose ballistic grade fibers are incorporated with the woven layers, having a tenacity of at least 15 grams per denier and tensile modulus of at least 400 grams per denier. Preferably the nonwoven fibers consist of a loose fiber batting entangled with the yarns of the woven layers by needlepunching, so that the fibers of the nonwoven layer are forced into the interstices of the matrix of the woven layers (i.e., z-directional reinforcement). The amount of nonwoven fibers in a denier gradient core matrix material according to the invention is in a range of about 1% to about 50% by weight, preferably, about 1% to about 10% by weight.

A finished ballistic product may incorporate a plurality of core matrix layers stitched together. Any type of stitching known in the art may be used, including, without limitation, a plain stitch, a quilt stitch and a cross stitch. In embodiments a finished ballistic product is prepared by attaching several core matrix layers with a stich around the perimeter and a cross stich. Preferably 2 to 50, and more preferably 2 to 5, core layers are combined in a finished product by stitching. Various backing materials may be used. However, the details of layering and stitching and making a finished product may be left to the skill of the designer and manufacturer of finished ballistic products.

Core matrix materials according to the invention preferably have areal weight in a range of about 0.07 pounds per square foot (PSF) to about 10 PSF. Multiple layers of consolidated denier gradient core material may be combined in a ballistic structure.

A denier gradient core matrix material having an areal weight of 0.7 to 0.8 pounds per square foot (psf) according to the invention preferably has a V-50 of at least 800 feet per second (fps), more preferably at least 1500 fps and most preferably 2000 fps against standard caliber rounds, including .44 mag and .357 mag. The V-50 performance of the denier gradient core material according to the invention may be compared to a ballistic material having the same areal weight constructed entirely of the lower denier material of the first ballistic material layer. As may be seen referring to TABLE 1 below, for example, reducing the denier of a plain weave ballistic fabric at a constant areal weight of 0.7-0.8 psf, results in increased V-50 performance. Surprisingly, when using a denier gradient core material, as in Example 1, combining low and high denier woven layers by needle punching, a higher V-50 results compared to the same weight of either woven material taken alone. Preferably, the material having an areal weight of 0.7 to 0.8 pounds per square foot has a V-50 at least about 10% higher than a ballistic material having the same areal density constructed entirely from the first woven ballistic fabric. More preferably, the material having an areal weight of 0.7 to 0.8 pounds per square foot has a V-50 at least about 15% higher than a ballistic material having the same areal density constructed entirely from the first woven ballistic fabric.

Another advantage noted with the denier gradient material according to the invention is improved trauma performance, especially against small caliber projectiles. The core material having an areal weight of 0.7 to 0.8 psf has a back face signature at V-0 velocity of less than 65 mm, and preferably less than 55 mm at V-50 velocity. The trauma performance of a denier gradient material according to the invention is preferably improved by at least 10 percent compared with a woven material having the same denier as either the high denier layer or the low denier layer. Of course, both V-50 and BFS are highly dependent on the caliber of the rounds used in the testing. The areal weight of 0.7 to 0.8 psf is selected to normalize testing results and compare materials and is not considered to limit the invention.

Materials according to the invention may be prepared by placing nonwoven material having an areal weight of up to about 15 ounces/sq. yard, preferably up to about 5 ounces/sq. yard, and a thickness of up to about 0.5 inches, preferably up to about 0.1 inches, at the inlet side of a needlepunch loom on an automatic roll feed system timed to feed the material at the same rate as the machine speed. A stack of low denier woven layers and high denier woven layers, combined by stitching, are arranged on the inlet side of a needlepunch loom with the nonwoven batting. The fabric type, number of layers and denier are set forth in the Examples.

The needlepunch loom may be used with a single pass or multiple passes, depending on the degree of consolidation required, as described in the aforesaid U.S. Pat. No. 7,101,818 incorporated by reference for this purpose.

### EXAMPLE 1

Two plain weave 500 d TWARON brand para-aramid low denier layers were provided together with two plain weave 1000 d TWARON brand para-aramid high denier layers at the inlet side of a needle punch loom, together with a loose fiber batting and needle punching. The resulting fabric had an areal density of 0.80 lbs/sq. ft.

V-50 results for materials according to embodiments of the invention, and Comparative Examples, are tabulated in Table 1. Comparative Examples 1, 2 and 3 demonstrate that a core matrix material made of a single denier, at the same material weight, shows increasing V-50 with decreasing denier for both large caliber and small caliber rounds. However, combining the 500 d and 1000 d woven materials in a denier gradient core matrix material according to the invention results in a higher V-50 than the same areal weight of either the 1000 d or the 500 d single-denier woven material.

TABLE 1

| | | | | | V-50 |
|---|---|---|---|---|---|
| | Denier | Type | Proj | | *(fps) |
| Comparative | 3000d | PW Fabric | 9 | mm | 1234 |
| Example 1 | | | .357 | Mag | 1303 |
| Comparative | 1500d | PW Fabric | 9 | mm | 1322 |
| Example 2 | | | .357 | Mag | 1333 |
| Comparative | 1000d | PW Fabric | 9 | mm | 1489 |
| Example 3 | | | .357 | Mag | 1401 |
| Comparative | 500d | PW Fabric | 9 | mm | 1523 |
| Example 4 | | | .357 | Mag | 1487 |
| Comparative | 500d | PW Fabric | 9 | mm | 1550 |
| Example 5* | | | .357 | Mag | 1550 |
| Example 1 | 1000d/500d | PW Fabric | 9 | mm | 1702 |
| | | | .357 | Mag | 1638 |

*high denier per filament

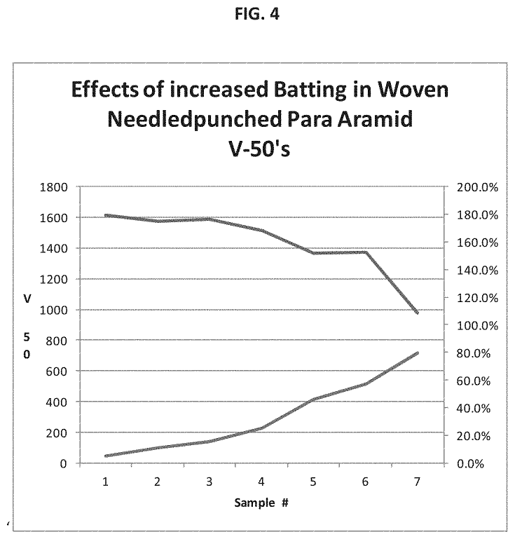

As shown in FIG. 4, an increase in the amount of nonwoven fiber in the core matrix decreases V-50, with a steeper decline noted at higher amounts of nonwoven in the finished material. In FIG. 4, the upper line reflects the V-50 data and the lower line reflects the nonwoven fiber content with the scale on the right hand side of the graph. Increasing the amount of low denier materials has the opposite effect. However, this trend is balanced by the back face signature of the finished product, with more nonwoven correlating with an improved back face signature

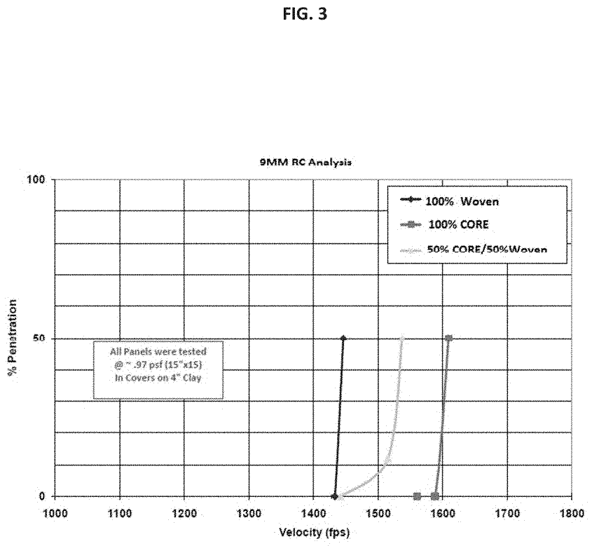

FIG. 3 demonstrates the effect of consolidating woven fabric and conventional core matrix material.

### Comparative Tests

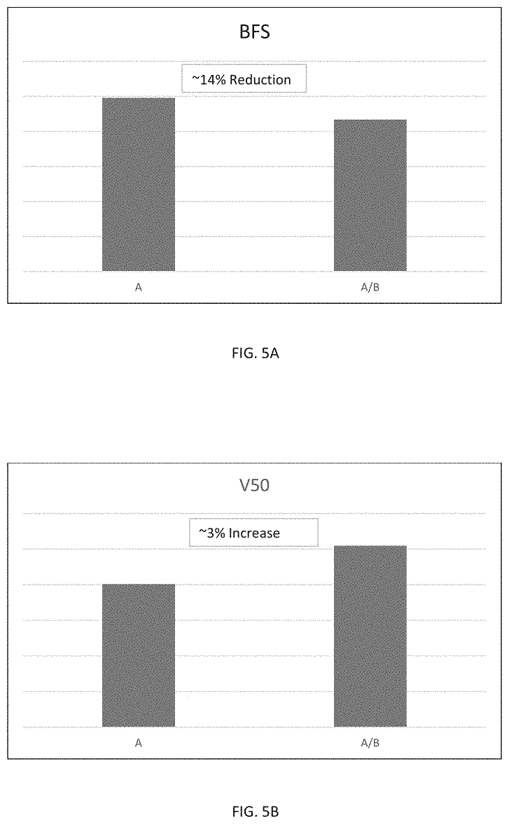

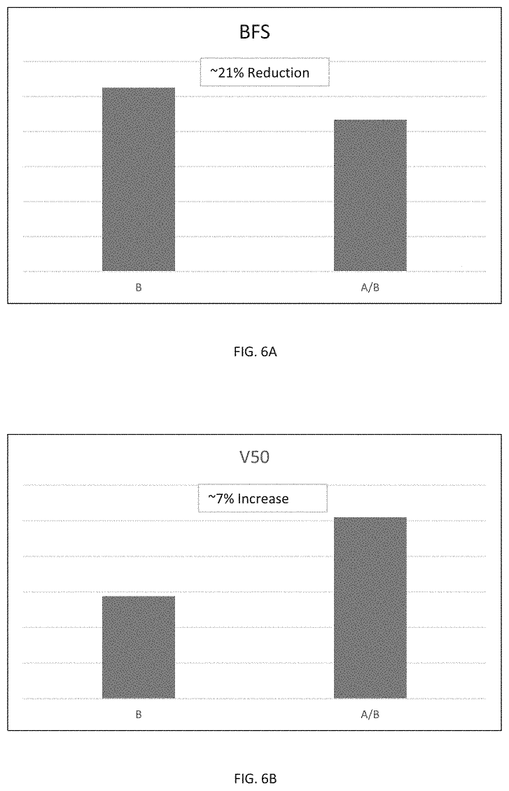

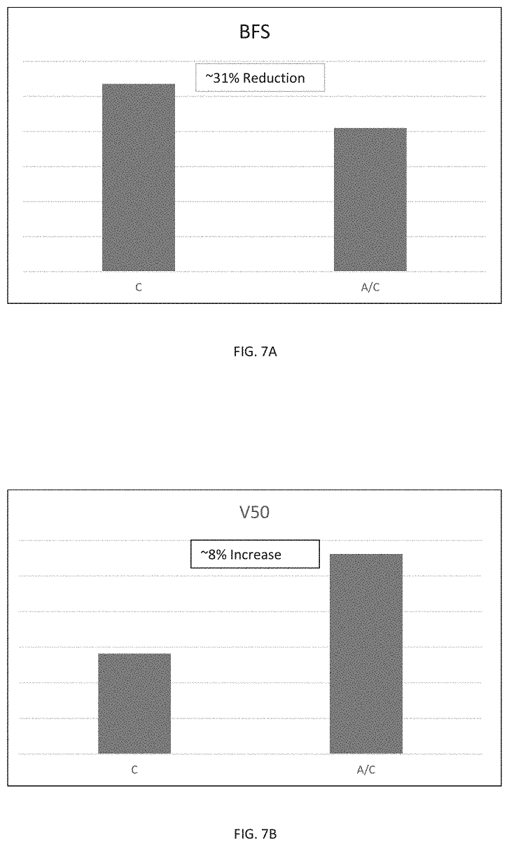

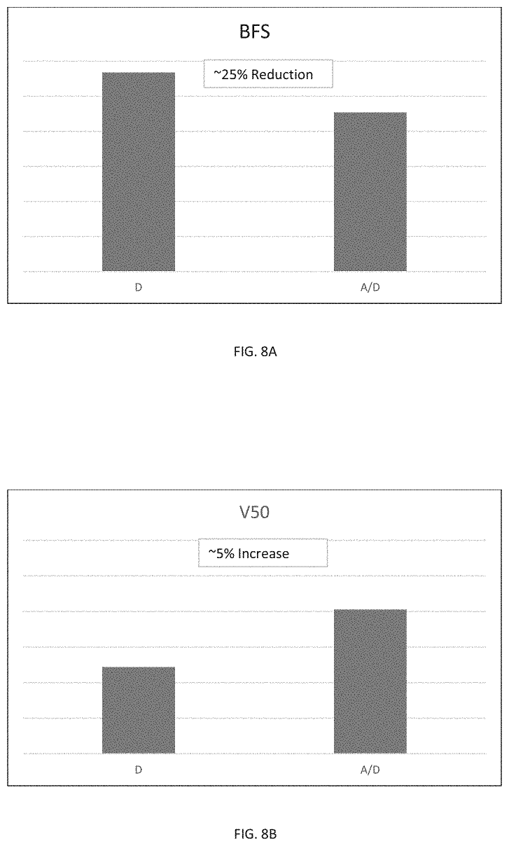

Ballistic tests were performed using fabrics produced from four denier grades. The results of ballistic testing are shown in FIG. 5A, FIG. 5B, FIG. 6A, FIG. 6B, FIG. 7A, FIG. 7B, FIG. 8A and FIG. 8B. The ballistic fabrics for these examples was prepared from para-aramid fibers A, B, C, and D having a denier in the range of 400-850 d, in order of increasing denier. Each tested panel of fabric had a ¾ lb areal weight and the same thickness. Each sample was subjected to ballistic impact using 9 mm rounds according to NIT 0101.06 V50 testing standards.

Comparing FIGS. 6A and 5A, a ballistic fabric comprised of a high denier fabric and a low denier fabric (A/B) demonstrates an improvement in backface signature performance (14% and 21% reduction) compared to an equivalent weight sample of either the high denier fabric B alone or the low denier fabric A alone. Comparing FIGS. 6B and 5B, the material according to the invention (A/B) also demonstrated an improvement in V-50 performance compared to both the low denier fabric A and the high denier fabric B. FIGS. 7A, 7B, 8A, and 8B demonstrate an improvement in ballistic performance achieved as the difference in denier between two different materials in a fabric according to the invention is increased. Thus, sample A/C (FIGS. 7A and 7B) and sample A/D (FIGS. 8A and 8B) represents a larger difference in denier than sample A/B in FIG. 5A and FIG. 6A. A greater improvement in BFS and V-50 performance is noted for certain of these fabrics when compared to the respective single denier fabric A, B, C, and D alone.

The foregoing description of the preferred embodiments is not to be deemed limiting of the invention, which is defined by the appended claims. The person of ordinary skill in the art, relying on the foregoing disclosure, may practice variants of the embodiments described without departing from the scope of the invention claimed. For example, although the examples were prepared within a relatively narrow set of fiber types and needlepunching parameters, it will be apparent to those of skill in the art that alternative fiber types may be used, necessitating needlepunching parameters suitable for those fiber types. A feature or dependent claim limitation described in connection with one embodiment or independent claim may be adapted for use with another embodiment or independent claim, without departing from the scope of the invention.

1. A ballistic material, comprising:
a first woven ballistic fabric having a first denier in a range of 50 d to 5000 d; and
a second woven ballistic fabric having a second denier in a range of 50 d to 5000 d, wherein the second woven ballistic fabric has a denier at least 15% greater than the first woven fabric; and
loose nonwoven fibers; wherein,
the first and second woven ballistic fabrics are consolidated by needlepunching to form a core material, wherein
the loose nonwoven fibers are inserted in the interstices of the first woven and second woven ballistic fabrics.

2. The ballistic material according to claim 1, wherein the second woven fabric has a denier at least 35% greater than the first woven fabric.

3. The ballistic material according to claim 1, wherein the first woven ballistic fabric has a denier of 50 d to 1500 d and the second ballistic fabric has a denier of 500 d to 5000 d.

4. The ballistic material according to claim 1, wherein the first woven ballistic fabric has a denier of 125 d to 850 d and the second ballistic fabric has a denier of 500 d to 5000 d.

5. The ballistic material according to claim 1, comprising 1 to 20 layers of the first woven ballistic fabric and 1 to 20 layers of the second woven ballistic fabric.

6. The ballistic material according to claim 1, wherein the first ballistic fabric and the second ballistic fabric comprise single component fibers, multi-component fibers or copolymer fibers selected from the group consisting of ballistic grade poly(amide) fibers, poly(aramid) fibers, ultra-high molecular weight polyethylene (UHMWPE) fibers, polyester fibers, poly(phenylene-2,6-benzobisoxazole) (PBO) fibers, graphene, spider silk, carbon nanotubes, and combinations thereof.

7. The ballistic material according to claim 1, wherein the first ballistic fabric and the second ballistic fabric consist essentially of para-aramid fibers.

8. The ballistic material according to claim 1, comprising 2 to 10 layers of 125 denier to 850 denier woven para aramid fibers, 2 to 10 layers of 500 denier to 5000 denier woven para aramid fibers, and nonwoven fibers, consolidated by needlepunching.

9. The ballistic material according to claim 1, comprising about 1% to about 50% loose nonwoven fibers.

10. The ballistic material according to claim 1, comprising about 1% to about 10% loose nonwoven fibers.

11. A ballistic material according to claim 1, having an areal density in a range of about 0.07 psf to about 10 psf.

12. A finished ballistic product having at least two core material layers according to claim 1, wherein each core material layer has an areal density in a range of about 0.07 psf to about 10 psf.

13. The ballistic material according to claim 12, having an areal weight of 0.7 to 0.8 pounds per square foot and V-50 of at least 1500 feet per second.

14. The ballistic material according to claim 12, having an areal weight of 0.7 to 0.8 pounds per square foot and V-50 at least about 5% higher than a ballistic material having the same areal density constructed entirely from the first woven ballistic fabric.

15. The ballistic material according to claim 12 having an areal weight of 0.7 to 0.8 pounds per square foot and a back face signature at least about 10% lower than a ballistic material having the same areal density constructed entirely from the second woven ballistic fabric.
